(19) United States
(12) Patent Application Publication
(10) Pub. No.: US 2005/0178231 A1
(43) Pub. Date: Aug. 18, 2005

(54) Steering column clamping device

(75) Inventors: Gary T. Schick, Goshen, CT (US); W. Richard Gist, Bristol, CT (US); Glenn DiCostanzo, Litchfield, CT (US); Michael C. Brauer, New Hartford, CT (US); Michael A. Ignaffo, Ypsilanti, MI (US)

Correspondence Address: MICHAEL BEST & FRIEDRICH, LLP, 100 E WISCONSIN AVENUE, MILWAUKEE, WI, 53202, US

(73) Assignee: Timken U.S. Corporation, Torrington, CT (US)

(21) Appl. No.: 10/779,489

(22) Filed: Feb. 13, 2004

(51) Int. Cl. B62D 1/18

(52) U.S. Cl. 74/493

(57) ABSTRACT

A cam locking assembly for an adjustable steering column. The assembly includes a tie bolt that is secured relative to the steering column. A lever member is positioned for rotation about the tie bolt. A caming unit is positioned about the tie bolt adjacent the lever member. The caming unit has a roller assembly positioned between a pair of opposed cam plates. One of the cam plates is associated with the lever member and rotates therewith and the other plate is fixed relative to such rotation. Each cam plate has a plurality of ramped recesses on its internal surface such that rotation of the one plate causes the rollers to ride up the ramps such that the plates are pushed apart. The pushed apart ramps cause clamping upon the steering column to lock its position.

This application claims priority to U.S. patent application Ser. No. 10/385,885, filed Mar. 10, 2003, which claims the benefit of U.S. provisional application No. 60/362,811 filed Mar. 8, 2002 and U.S. patent application Ser. No. 09/966,217, filed Sep. 27, 2001, which claims the benefit of U.S. provisional application No. 60/246,002 filed Nov. 3, 2000.

### BACKGROUND

The present invention relates to adjustable steering columns. More particularly, the present invention relates to a cam locking assembly for use in conjunction with an adjustable steering column.

For user convenience, many vehicles provide a steering column that permits tilting or tilting and telescoping thereof to meet the users preferences. Upon proper adjustment, the steering column must be fixed to prevent movement of the steering column during vehicle operation. It is desired to provide a locking mechanism that allows relatively easy release to allow adjustment, but also provides adequate fixing of the steering column.

Compared to simple cam locks with sliding surfaces, the rolling contact provided by rolling cam mechanisms reduces friction and operator effort while effecting a significantly greater clamping force. Some of these ball cam mechanisms are configured such that an actuating lever drives the rolling elements, thereby ensuring the position of each rolling element in relation to a known locked or unlocked lever position.

Rolling cam mechanisms according to the prior art are not suitable for use as a lock mechanism for a steering column position adjustment. If such ramped roller track mechanisms were used in that application, the locking clamp loads would not be satisfactory because the rolling elements would not track precisely enough to ensure that locking would occur every time every time the steering column position was adjusted, with no slipping.

The foregoing illustrates limitations known to exist in present devices and methods. Thus, it is apparent that it would be advantageous to provide an alternative directed to overcoming one or more of the limitations set forth above. Accordingly, a suitable alternative is provided including features more fully disclosed hereinafter.

### SUMMARY

The present invention provides a cam locking assembly for an adjustable steering column. The cam locking assembly includes a tie bolt that is secured relative to and extends from the steering column. A lever member is positioned for rotation about the tie bolt. A caming unit is positioned about the tie bolt adjacent the lever member. The preferred caming unit has a roller assembly positioned between a pair of opposed cam plates. One of the cam plates is associated with the lever member such that the plate rotates with the lever and the other plate is fixed relative to such rotation. Each cam plate has a plurality of ramped recesses on its internal surface such that rotation of the one plate causes the rollers to ride up the ramps such that the plates are pushed apart. The pushed apart ramps cause clamping upon the steering column in a locked position. A retainer positioned between the plates maintains the rolling elements in the proper position and orientation.

### BRIEF DESCRIPTION OF THE DRAWINGS

FIG. 1 is an exploded isometric view of a cam locking assembly in accordance with a first embodiment of the present invention.

FIG. 2 is an isometric view of an assembled cam locking assembly of FIG. 1.

FIG. 3 is an isometric view of a cam plate in accordance with a first embodiment of the present invention.

FIG. 4 is a side elevational view along the line 4-4 in FIG. 3.

FIG. 5 is an isometric view of the caming unit of the cam locking assembly of FIG. 1 with a cut away portion removed for clarity.

FIG. 6 is a cross-sectional elevational view of a cam locking assembly in accordance with FIG. 1 associated with a steering column assembly.

FIGS. 7a and 7b are axial views of a ball ramp actuator, with internal ball tracks indicated by dotted lines, with FIG. 7a illustrating the balls in an outer position and FIG. 3b illustrating the balls in an inner position after relative rotation of the cam plates.

FIGS. 8-11 are axial views of various ball retainers that may be used with alternative embodiments of the present invention.

FIG. 12 is an enlarged sectional view of the ball retainer of FIG. 5, as indicated by the line 12-12 of FIG. 9.

FIG. 13 is a cross-sectional elevational view of a cam locking assembly in accordance with a second embodiment associated with a steering column assembly.

FIG. 14 is an isometric view of an exemplary spline plate used in conjunction with the cam locking assembly of FIG. 13.

### DETAILED DESCRIPTION OF THE PREFERRED EMBODIMENTS

The present invention will be described with reference to the accompanying drawing figures wherein like numbers represent like elements throughout. Certain terminology, for example, “top”, “bottom”, “right”, “left”, “front”, “frontward”, “forward”, “back”, “rear” and “rearward”, is used in the following description for relative descriptive clarity only and is not intended to be limiting.

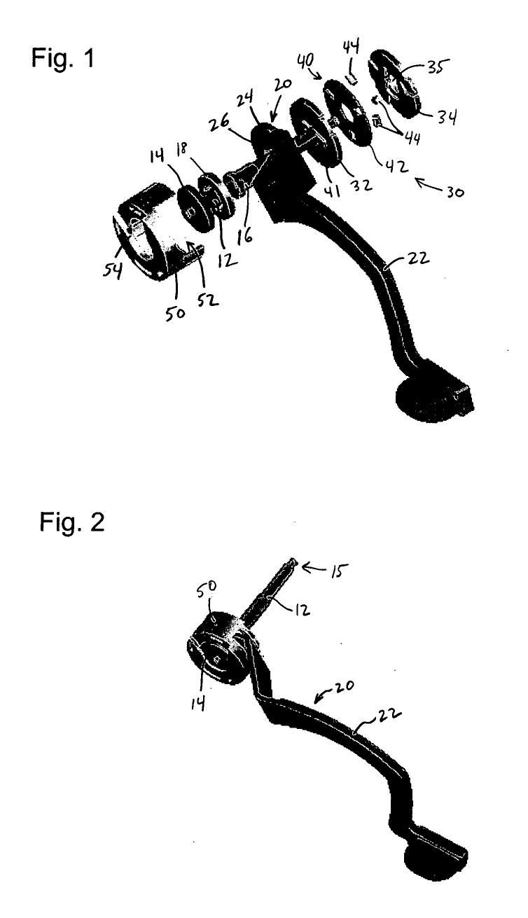

Referring to FIGS. 1-5, a first embodiment of a cam locking assembly 10 in accordance with a first embodiment of the present invention is shown. The cam locking assembly 10 generally includes a tie bolt 12, a thrust bearing assembly 18, a lever member 20 and a caming unit 30.

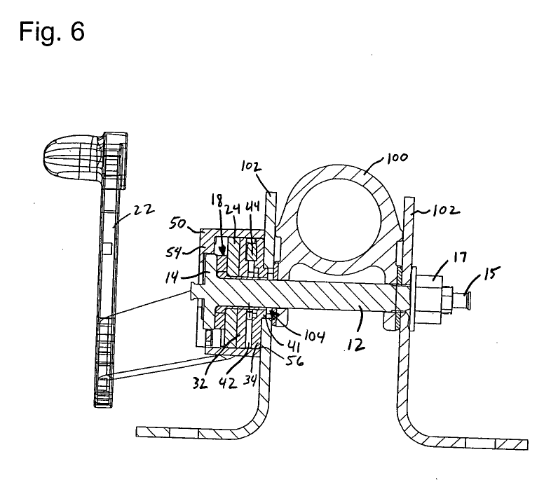

The tie bolt 12 terminates in a retaining plate 14 at one end and an is generally free at the opposite end 15. The retaining plate 14 may be an integrally formed flange, as illustrated, or the retaining plate 14 may be formed as a separate washer or the like secured along the tie bolt 12. The free end 15 is configured for securement relative to a steering column (See FIGS. 6 and 8). For example, the free end 15 is preferably threaded to receive a nut 17 or the like.

The lever unit 20 preferably includes an extending handle 22 connected to a plate 24. The plate 24 has an aperture 26 therethrough configured to receive the tie bolt 12 such that the plate 24 may be rotated thereabout. A sleeve member 16 may be provided about the tie bolt 12 to help facilitate rotation of the lever unit 20. If a sleeve member 16 is provided, the aperture 26 is configured to fit about the sleeve member 16. In the illustrated embodiment, the thrust bearing assembly 18 is positioned between the retaining plate 14 and the lever plate 24 to further facilitate rotation of the lever unit 20. The thrust bearing 18 may otherwise be positioned. For example, if the tie bolt 12 rotates with the lever unit 20, the thrust bearing 18 may be positioned between the steering wheel bracket 102 and the nut 17. Furthermore, more than one thrust bearing may be utilized. The thrust bearing assembly 18 can have various configurations, but generally comprises a plurality of roller elements retained in a cage or the like. The opposite side of the lever plate 24 is configured to engage the caming unit 30, as will be described in greater detail hereinafter.

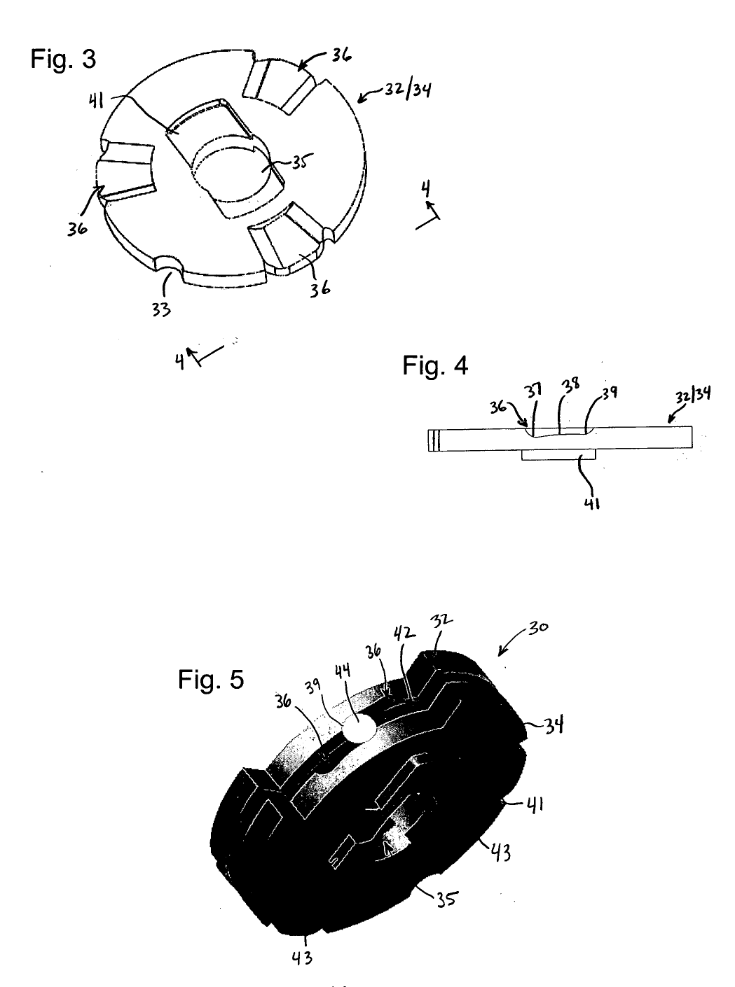

The caming unit 30 generally comprises a pair of opposed cam plates 32 and 34 with a roller assembly 40 positioned therebetween. The preferred roller assembly 40 includes a plurality of rollers 44 maintained in a retainer plate 42. The retainer plate 42 maintains the rollers 44 in proper position and orientation as the cam plates 32 and 34 are rotated relatative to one another. Referring to FIGS. 3 and 4, the preferred cam plates 32 and 34 will be described. Each cam plate 32, 34 is a generally planar disk with a central bore 35 configured to receive the tie bolt 12. One or more alignment notches 33 may be provided along the disk. For example, the notches 33 may align with a tab on the retainer clip 50 to ensure that the cams are in an initial locked position.

One surface of the disk has a plurality of ramp recesses 36. In the preferred embodiment, three evenly spaced recesses 36 are provided. Fewer or more recesses 36 also may be provided. The recesses 36 include a deep trough portion 37 and a shallow trough portion 39, each configured to receive at least a portion of one of the rollers 44. A ramp 38 extends between the trough portions 37, 39. As shown in FIG. 5, the ramp recesses 36 on opposite plates 32, 34 are preferably reversed from one another, i.e., the ramps 38 of one of the plates 32 extend clockwise while the ramps 38 of the other plate 34 extend counter-clockwise. As such, in the unlocked position each roller 44 is positioned in a pair of opposed deep troughs 37. As the plates 32, 34 are rotated relative to one another, as will be explained hereinafter, the rollers 44 ride up the opposed ramps 38 until the rollers 44 are received in the respective shallow troughs 39. The positioning of the rollers 44 within the diminished depths of the shallow troughs 39 causes the plates 32 and 34 to push apart and thereby lock the steering column. The troughs 39 preferably have a semi-circular configuration such that the rollers 44 are retained therein.

The opposite side of each plate 32, 34 has a locking protrusion 41 extending therefrom. The preferred protrusion 41 is positioned about the central bore 35 and has an elongated configuration with opposed flat sides 43. The protrusion 41 may have various configurations. Furthermore, more than one protrusion may be provided. The protrusion 41 of plate 32 is configured to be received in the bore 26 of the lever plate 24 such that cam plate 32 rotates in conjunction with the rotation of the lever plate 24. Other means of securing the cam plate 32 to the lever plate 24 may also be used. The protrusion 41 of plate 34 is received in a bore 104 of the column mounting arm (see FIG. 6) to prevent rotation of the plate 34. With respect to engagement, each plate 32, 34 may alternatively be provided with a receiving bore and the respective engagement surfaces, the lever plate 25 and mounting arm, be provided with protrusions. In the preferred embodiment, the protrusions 41 extending from the plates 32 and 34 are identical such that a single plate may be manufactured and utilized for both plates 32 and 34.

Referring to FIGS. 1, 2 and 6, a retainer clip 50 is preferably provided to unitize the cam locking assembly 10. The retainer clip 50 preferably has a first lip 54 configured to engage the retaining plate 14. The opposite end of the clip 50 has a second lip 56 configured to engage the fixed cam plate 34, thereby unitizing the cam locking assembly 10. In the preferred embodiment, the second lip 56 is configured such that upon securing of the cam locking assembly 10 onto a steering assembly, see FIG. 6, the moves out of the way to prevent trapping of the lip 56 between the cam plate 34 and the bracket 102. The retainer clip 50 includes a lever passage 52 configured to fit about the lever unit handle 22. The retainer clip 50 rotates with the lever unit 20 and therefore, the lever passage 52 can provide a close fit about the handle 22. The retainer clip 50 can be manufactured in various manners and is preferably molded from polypropylene or the like.

Referring to FIG. 6, the cam locking assembly 10 is assembled and the tie bolt 12 is passed through a steering column 100, positioned between a pair of opposed brackets 102. As the cam locking assembly 10 is positioned, the protrusion 41 of cam plate 34 is received in the bore 104 of bracket 102. The tie bolt 12 is then secured via the nut 17 or the like and the cam plate 34 is thereby fixed relative to the bracket 102. Rotation of the handle 22 causes rotation of cam plate 32 between a lock position wherein the rollers 44 are positioned in the shallow troughs 39, thereby applying pressure to the opposed brackets 102, and an open position wherein the rollers 44 align with the deep troughs 37 such that the pressure is relieved. The steering column 100 can then be adjusted. A wave spring (not shown) or the like may be provided to preload the assembly 10.

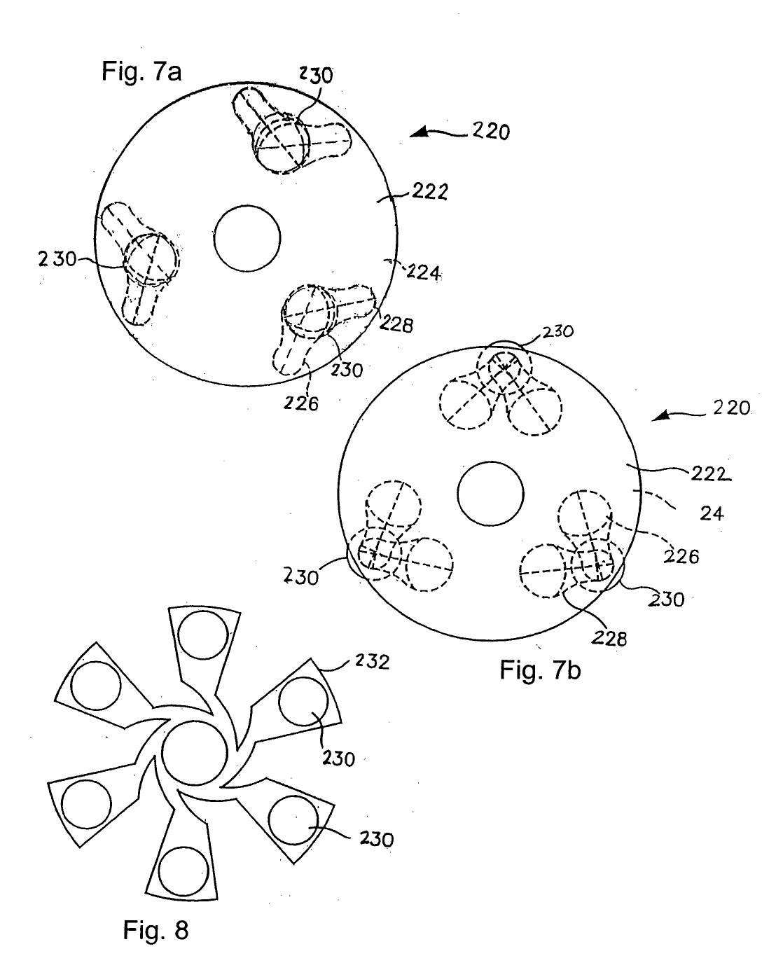

Referring to FIGS. 7-12, an alternate embodiment of the cam plates 222, 224 will be described. Two identical plates 222, 224 may be used, facing each other, to achieve an intersecting configuration (when viewed axially) that defines a precise location of a ball during its movement up and/or down the ramps of the respective ball tracks. This reduces ball slippage with respect to each plate and increases the reliability of locking effected by the actuating mechanism.

FIGS. 7a and 7b are axial views of a ball ramp actuator 220, with FIG. 7a illustrating the balls in an outer position and FIG. 7b illustrating the balls in an inner position after relative rotation of the cam plates 222, 224. The ball ramp actuator 220 comprises two identical cam plates 222 and 224 with non-circumferential ball tracks, comprising grooves 226 and 228, facing each other, with three balls 230 therebetween. As the cam plates 222 and 224 are rotated with respect to each other, the balls 230 are driven radially, while staying in the intersecting opposed ball tracks, ensuring their precise location as they move up and down the ramps of the grooves 226 and 228, without slippage.

Ball ramp actuator 220 may be mounted on a steering column, for example, for spreading apart or squeezing together members to lock the steering column after adjustment of tilt or length. In such an application, one cam plate 222 may be fixed against rotation and the other cam plate 224 may be rotatable by a lever arm to allow an operator to effect locking and unlocking of position of the steering column. Other anticipated applications may be similar.

This design, using a non-concentric ball ramp path, imparts a radial motion (either radially inward or radially outward) to the balls 226 when the ball ramp actuator 220 is moved into the locked or unlocked position. When rotating a lever arm into a locked or unlocked position, the balls 230 move radially inward or radially outward, depending on the configuration of the ramps. The ramps may direct the balls 230 axially inward or outward, as the ball moves radially in response to movement of the lever arm.

Furthermore, the shape of the non-concentric ramps may be varied to change the performance of the actuator such that one can minimize effort at peak load, or to alter the locking versus unlocking engagement effort.

A preferred method of making the cam plates 222 and 224 suitable for the invention is to progressively form the ramp shapes from metal strip. An anti-rotation (or stop) feature may be formed in that way at the same time the ramp is formed. Other methods of manufacture of the cam plates may be by CNC machining directly from stock or by powdermetal forming. If required loads are sufficiently light, the cam plates 222 and 224 may be economically formed of a polymer by injection molding.

If one or more balls 230 remain in an unlocked position despite the remainder of the mechanism moving to a locked position, this non-engagement or partial engagement of the balls may result in unreliable clamp loads and excessive wear. The risk of this condition is greatest when a moment is applied to the lever of the actuating mechanism that urges the cam plates 222 and 224 into a non-parallel relationship.

To reduce or eliminate any risk of non-engagement or partial engagement of the balls, a spring-integrated retainer or other biasing means may be provided to apply a small biasing pre-load onto the balls to ensure that the balls stay in contact with the ramps during locking and unlocking. Ensuring this contact prevents the balls from remaining in an unlocked position when the mechanism is moved into a locked position.

FIGS. 8-11 illustrate possible ball retainers 232, 234, 236 and 238, respectively, that deform elastically to provide the biasing of the balls 230, as just described. Each ball retainer may be molded of nylon, or other suitable flexible polymer, or may be made of metal. These configurations may bias the balls 230 either radially outward or, alternatively, radially inward. As illustrated, the number of balls 230 may be increased to increase load capacity of the ball ramp actuator.

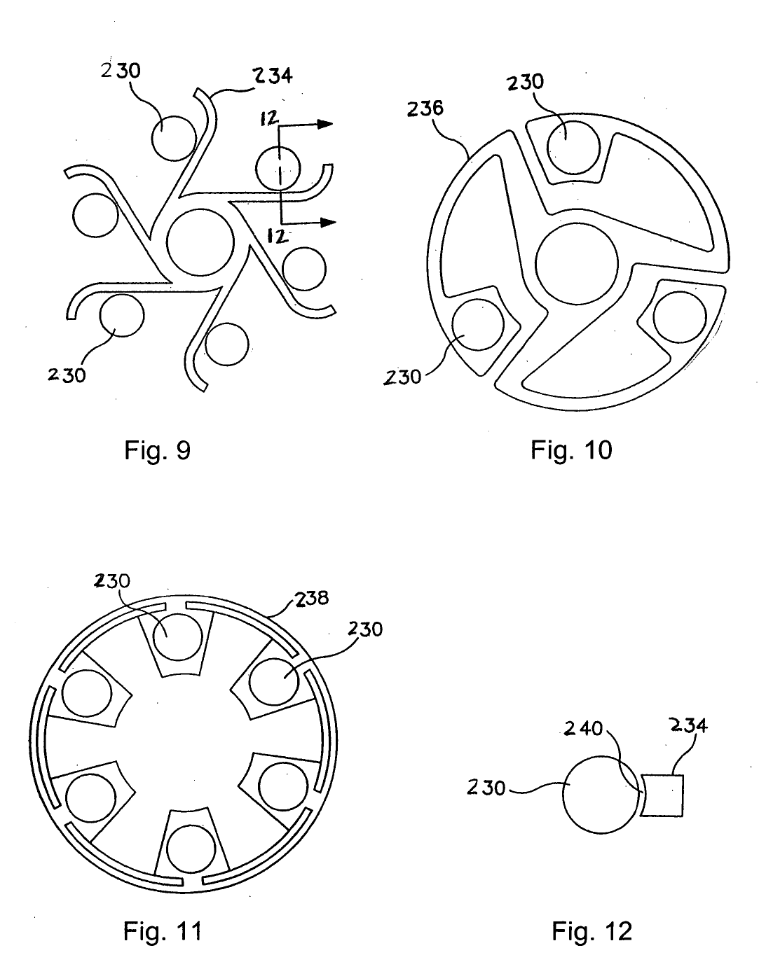

The ball retainers 232, 236 and 238 of FIGS. 8, 10 and 11, respectively, have round pockets for the balls 230. The ball retainer 234 of FIG. 9 has flexible arms that allow the balls 230 to ride up and down along the arms. The arms may overlap, as shown in FIG. 9, to reduce the risk of spring arm “set”. This configuration also maintains a relatively even spring force through all ball positions.

FIG. 12 illustrates that the arms of ball retainer 234 of FIG. 9 may have a concave surface in contact with the balls 230 to keep the arms centered with respect to the balls 230. This feature is particularly useful because the two cam plates 222 and 224 move axially apart and together to locked and unlocked positions, requiring a retainer that does not become wedged under the balls, thereby limiting their movement up or down the ball ramps.

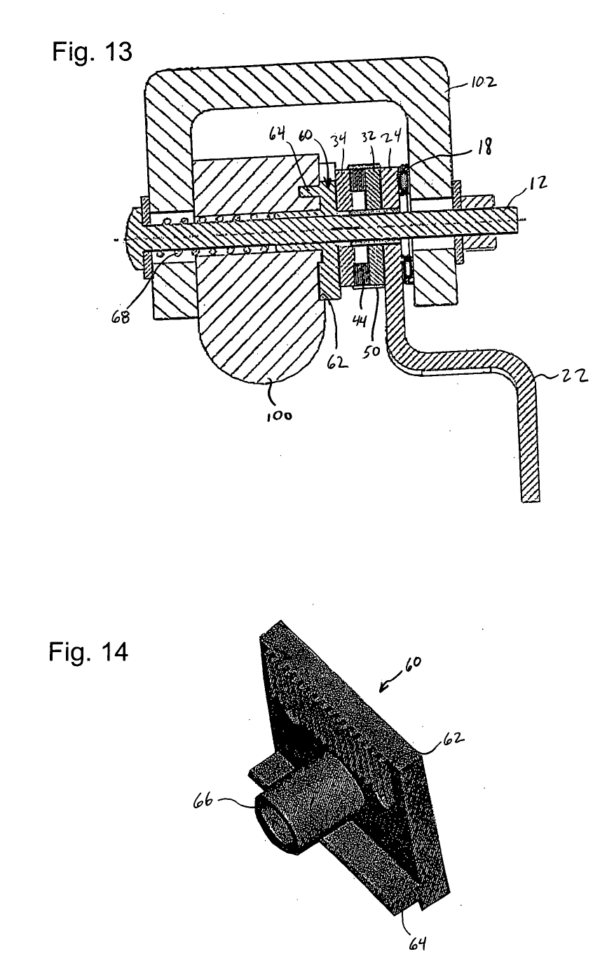

Referring to FIGS. 13 and 14, an alternate embodiment of the present invention is shown. The cam locking assembly 10 is substantially the same as in the previous embodiment. However, cam plate 34 of the present invention is connected to a spline plate 60, instead of directly to the mounting bracket 102 or column 100. The spline plate 60 in turn has splines 62 which are configured to mate with splines (not shown) on the column 100 and an alignment protrusion 64 received in the column 100 to prevent rotation of the spline plate 60 or cam plate 34. The spline plate 60 may also include a sleeve 66 positioned about the shaft. The cam locking assembly 10 is positioned within the brackets 102. A spring 68 or the like is positioned about the tie bolt 12 and biases the spline plate 60 away from the column 100, such that upon release of the cam locking assembly 10, the spline plate 60 releases the column 100 such that it can be tilted or extended. As will be understood, the cam plate 34 may directly engage the steering column 100 or bracket 102 or other engagement means, including the above described spline plate 60.

1. A cam locking assembly comprising:
a tie bolt;
a lever unit positioned about and rotatable about the tie bolt; and
a cam unit positioned about the tie bolt adjacent the lever unit, the cam unit comprising:
first and second cam plates, each cam plate comprising a first surface having at least one roller retaining recess, the first and second cam plates positioned with the first surfaces facing one another with the retaining recesses aligned and one of the cam plates engaged by and moveable with the lever unit;
a roller positioned between the opposed retainer recesses; and
a retainer about the roller configured to maintain the proper position and orientation of the roller.

2. The cam locking assembly of claim 1 wherein the first and second cam plates are substantially identical.

3. The cam locking assembly of claim 1 wherein each recess includes a shallow trough, a deep trough and a ramp extending therebetween.

4. The cam locking assembly of claim 3 wherein the recess of the first cam plate is configured such that the ramp extends from the deep trough to the shallow trough in a first direction and the recess of the second cam plate is configured such that the ramp extends from the deep trough to the shallow trough in a second, opposite direction.

5. The cam locking assembly of claim 1 wherein each cam plate has a second surface opposite the first surface and at least one protrusion extends from the second surface.

6. The cam locking assembly of claim 5 wherein each cam plate has a central bore and the protrusion extends about the central bore and has an elongated configuration with opposed flat sides.

7. The cam locking assembly of claim 6 wherein the lever unit includes a lever plate having a central aperture with an elongated configuration substantially the same as the configuration of the first cam plate protrusion.

8. The cam locking assembly of claim 1 wherein each cam plate includes three equally spaced retaining recesses.

9. The cam locking assembly of claim 1 further comprising a retainer clip positioned about a portion of the lever unit and the cam unit, the retainer clip configured to rotate with the lever unit.

10. The cam locking assembly of claim 9 wherein the lever unit includes a handle extending through a lever passage in the retainer clip, the lever passage having a close fit about the handle.

11. The cam locking assembly of claim 1 wherein the second cam plate engages a splined plate.

12. An adjustable steering column assembly comprising:
a steering column;
a support bracket; and
cam locking assembly comprising:
a tie bolt extending through the steering column and support bracket;
a lever unit positioned about and rotatable about the tie bolt; and
a cam unit positioned about the tie bolt adjacent the lever unit, the cam unit comprising:
first and second cam plates, each cam plate comprising a first surface having at least one roller retaining recess, the first and second cam plates positioned with the first surfaces facing one another with the retaining recesses aligned and one of the cam plates engaged by and moveable with the lever unit; and
a roller positioned between the opposed retainer recesses; and
a retainer about the roller configured to maintain the proper position and orientation of the roller.

13. The steering column assembly of claim 12 wherein the first and second cam plates are substantially identical.

14. The steering column assembly of claim 12 wherein each recess includes a shallow trough, a deep trough and a ramp extending therebetween.

15. The steering column assembly of claim 14 wherein the recess of the first cam plate is configured such that the ramp extends from the deep trough to the shallow trough in a first direction and the recess of the second cam plate is configured such that the ramp extends from the deep trough to the shallow trough in a second, opposite direction.

16. The steering column assembly of claim 12 wherein each cam plate has a second surface opposite the first surface and at least one protrusion extends from the second surface.

17. The steering column assembly of claim 16 wherein each cam plate has a central bore and the protrusion extends about the central bore and has an elongated configuration with opposed flat sides.

18. The steering column assembly of claim 17 wherein the lever unit includes a lever plate having a central aperture with an elongated configuration substantially the same as the configuration of the first cam plate protrusion.

19. The steering column assembly of claim 12 wherein each cam plate includes three equally spaced retaining recesses.

20. The steering column assembly of claim 12 further comprising a retainer clip positioned about a portion of the lever unit and the cam unit, the retainer clip configured to rotate with the lever unit.

21. The steering column assembly of claim 20 wherein the lever unit includes a handle extending through a lever passage in the retainer clip, the lever passage having a close fit about the handle.

22. The steering column assembly of claim 12 wherein the second cam plate engages a splined plate that engages splines extending along the steering column.

23. The steering column assembly of claim 12 wherein the support bracket includes spaced apart bracket arms and the steering column is positioned between the bracket arms and the cam locking assembly is positioned outside the bracket arms.

24. The steering column assembly of claim 12 wherein the support bracket includes spaced apart bracket arms and the steering column and the cam locking assembly are positioned between the bracket arms.
